(19) United States
(12) Patent Application Publication
(10) Pub. No.: US 2008/0299406 A1
(43) Pub. Date: Dec. 4, 2008

(54) Split Leather for Car Seats and Manufacturing Method Thereof

(75) Inventor: Sam Keun Lee, Busan (KR)

Correspondence Address: Hyun Jong Park;TUCHMAN & PARK LLC, 41 White Birch Road, Redding, CT, 06896-2209, US

(73) Assignee: Nam Chung Co., LTD., Busan (KR)

(21) Appl. No.: 12/129,649

(22) Filed: May 29, 2008

(30) Foreign Application Priority Data
May 31, 2007 (KR) 10-2007-0053366

(51) Int. Cl. C14C 9/00; D06P 3/00; D06P 5/02; C14C 3/00; D06P 3/32

(52) U.S. Cl. 428/540; 8/436; 8/437

(57) ABSTRACT

Disclosed herein are split leather for car seats and a manufacturing method thereof. The method comprises a preparation process, a tanning process, a pre-dyeing process, a dyeing process, a drying process and a finishing process, wherein the method comprises, after the preparation process, but before the tanning process, a re-splitting process of splitting pelt into an upper grain layer and a split layer, having a thickness of 2.5-4 mm, and re-splitting the split layer to have a thickness of 1.8-2.5 mm starting from the upper side thereof, thus obtaining split leather, and the finishing process comprises sequentially forming a roll base sealing layer, a roll base cover layer, a medium color top coating layer and a final top coating layer on the split leather, thus treating the surface of the split leather. The split leather for car seats has a luxuriousness close to that of full-grain leather and a soft touch and feel, and can give customers a cost advantage. Also, the range of selection of raw material for manufacturing car seat leather can be widened, and waste can be recycled to thus reduce the generation of waste, thus being helpful to the environment. In addition, leather seats can be diversified and a new product group can be created.

### FIELD OF THE INVENTION

The present invention relates to split leather for car seats and a manufacturing method thereof, and more particularly to split leather for car seats, which has a luxuriousness close to that of deluxe full-grain leather and a soft touch and feel and shows excellent durability, and can be manufactured using a split leather layer, which is unavoidably generated in a process of splitting leather in a cross-sectional direction to control the thickness of leather during leather processing.

### BACKGROUND OF THE INVENTION

Natural leather, which is a natural material obtained from livestock having a close relationship with people, is an environmental-friendly natural material that has long played a role in human history. The skin obtained from animals is called “hide”, and a skin obtained by salting the hide to prevent the deterioration thereof and facilitate the transport thereof is called a “pelt”. Pelts are processed through a preparation process, a tanning process and a finishing process, such that they can be used as products.

Herein, the pelt consists of two layers, an upper grain layer of fur, and a lower split layer including meat. The pelt is split into the grain layer and the split layer in leather processing factories. The grain layer has been processed into grain leather, which is widely used in car seats, and the split layer has generally been used as mid- and low-priced chamois leather or as products comprising polyurethane (PU) coated on the surface thereof.

As shown in FIG. 1, a method for manufacturing such grain leather sequentially comprises a preparation process, a tanning process, a pre-dyeing process, a dyeing process, a drying process and a finishing process.

First, the preparation process comprises a soaking step of removing salt and contaminants and replenishing water to restore the pelt to its original hide state, a liming step of chemically removing fibrous proteins from the fur surface layer of the pelt, a fleshing step of removing fat and meat from the pelt, and a sorting step of grading the hide according to the condition thereof and classifying it according to the intended use thereof.

Then, the tanning process is carried out to allow the fibrous tissue of the pelt to bind to a tanning material so as to have a stabilized fibrous tissue. It comprises a deliming step of immersing the pelt in a solution of acid or ammonium salt to neutralize and elute lime bound to the leather, a bating step of adding protease to the solution to digest and remove unnecessary proteins other than collagen, a pickling step of immersing the pelt in acid to reach a pH suitable for tanning, and a tanning & fixation step of allowing the collagen protein, which has an unstable structure, to bind to a tanning material to convert it into a protein having a stable structure, thus improving physical properties, such as heat resistance, deterioration resistance and softness.

Subsequently, the pre-dyeing process comprises a samming step of removing excessive water to facilitate a subsequent shaving step, a re-splitting step of separating the pelt into a grain layer and a split layer, and a shaving step of adjusting the thickness of the final product to meet the requirement of buyers.

Subsequently, the dyeing process is carried out to impart colors and improve required properties, such as water resistance, tensile strength and tearing strength, and comprises: a first retanning step of using a combination of various tanning agents to express various required qualities of the leather, which greatly influences subsequent dyeing and fatliquoring processes to influence penetration, dyeing uniformity, absorption and the like; a neutralization step of reducing acidity and positive (+) charges using alkaline chemicals, because the chromium-tanned leather carries strong positive (+) charges, so that retanning agents, dyes and fatliquoring agents, which are used in subsequent processes, mostly carry negative (−) charges, and thus there is the risk of a reaction occurring too rapidly and non-uniformly; a second retanning step; a dyeing step of obtained the obtained color using dyes; and a fatliquoring step of applying various kinds of oils on the fibrous tissue through a suitable method to improve physical properties, such as softness, elasticity, moisturizing properties and tension.

Subsequently, the drying process is carried out to maintain ideal temperature, humidity and time, because it has a close connection with the tactile feel, thickness, color and yield of leather.

Subsequently, the finishing process is carried out to apply water in order to prevent damage to the fibrous tissue and soften the fibrous tissue in subsequent processes (staking and milling), because part of the leather is excessively dried to become hard in the drying process, and a lot of shrinkage occurs at the time of drying. It comprises a color application step of spraying the surface of the leather with a blend of pigments, adhesives and chemicals depending on the color of the leather, an aging step and a peeling step.

Finally, a measuring process of measuring the area (S/F(Ft²)) of the final product is conducted.

In the case of the grain leather manufactured by this prior manufacturing method, it is evenly tanned, even when the tanning process is carried out immediately after the preparation process, but in the case of the split leather, because it is very thick and contains a thick fatty layer, it must be subjected to the resplitting process. Thus, the prior method had a problem in that the split leather is not evenly tanned, because the resplitting process is carried out following the tanning process.

Also, general grain leather for car seats has a thickness of 1.0-1.4 mm and comprises an upper grain layer, having a thickness of 0.4-0.6 mm, and a lower split layer, having a thickness of 0.5-1.0 mm. The fibrous texture of the lower split layer is rough and coarse toward the subcutaneous tissue, and for this reason, the prior method has a problem in that, in order to treat the rough surface to use the split leather for car seats, an expensive film is attached to the split leather with a bonding agent to produce synthetic leather, thus increasing the cost of the leather.

Also, the split leather manufactured according to the prior method has a problem in that, because the thickness thereof is thick, the split leather cannot be imparted with a soft texture like that of full-grain leather.

### SUMMARY OF THE INVENTION

Accordingly, the present invention has been made in order to solve the problems occurring in the prior art, and it is an object of the present invention to provide split leather for car seats and a manufacturing method thereof, which can maximally maintain the properties of grain leather by improving processes for manufacturing low-price split leather products and, at the same time, can provide a cost advantage, resulting from the use of low-priced raw materials for split leather, to popularize leather seats and create a new product group.

To achieve the above object, according to a preferred embodiment of the present invention, there is provided a method for manufacturing split leather for car seats, comprising a preparation process, a tanning process, a pre-dyeing process, a dyeing process, a drying process and a finishing process, wherein the method comprises, after the preparation process, but before the tanning process, a re-splitting process of splitting pelt into an upper grain layer and a split layer, having a thickness of 2.5-4 mm, and re-splitting the split layer to have a thickness of 1.8-2.5 mm starting from the upper side thereof, thus obtaining split leather, and the finishing process comprises sequentially forming a roll base sealing layer, a roll base cover layer, a medium color top coating layer and a final top coating layer on the split leather, thus treating the surface of the split leather.

The roll base sealing layer according to the present invention is preferably formed using a roll base sealing process, in which a urethane resin mixture, comprising 100 parts by weight of a 1:1 mixture of filler silica and pigment, 700-800 parts by weight of water-based material and 100-150 parts by weight of a urethane binder, is applied on the surface of the split leather after the dyeing process through a dry direct coating method.

Also, the roll base cover coating layer according to the present invention is preferably formed using a roll base cover coating process, in which a preliminary color is applied to the split leather using a coating solution, comprising 100 parts by weight of a mixture of wax and oil, 180-200 parts by weight of filler silica, 150-160 parts by weight of filler silica, 230-250 parts by weight of an acrylic binder, 300-350 parts by weight of a urethane binder and 1-200 parts by weight of a urethane top coat, through a dry direct coating method.

In addition, the medium color top coating layer according to the present invention is preferably formed using a medium color top coating process, in which a coating solution, comprising 100 parts by weight of a pigment, 70-90 parts by weight of wax and oil, 120-200 parts by weight of filler silica, 250-300 parts by weight of acrylic binder, 300-350 parts by weight of a urethane binder, 150-200 parts by weight of a urethane top coat, 20 parts by weight of a silicone modifier and 1-20 parts by weight of a crosslinker, is coated on the split leather through a dry direct coating method, thus determining the final color of the split leather and forming a preliminary protective film.

In addition, the final top coating layer according to the present invention is preferably formed using a final top coating process, in which a coating solution, comprising 100 parts by weight of a urethane binder, 550-650 parts by weight of a urethane top coat, 45-55 parts by weight of a silicone antifouling agent, 80-120 parts by weight of a silicone modifier and 100-150 parts by weight of a crosslinker, is applied on the split leather through a dry direct coating method, thus forming a final protective film.

According to another embodiment of the present invention, there is provided split leather for car seats, manufactured according to the above-described manufacturing method.

### BRIEF DESCRIPTION OF THE DRAWINGS

The above and other objects, features and advantages of the present invention will be more clearly understood from the following detailed description taken in conjunction with the accompanying drawing, in which:

FIG. 1 is a flowchart comparing side by side a prior process for manufacturing grain leather for car seats and an inventive process for manufacturing split leather for car seats according to an embodiment of the present invention.

### DETAILED DESCRIPTION OF THE INVENTION

Hereinafter, split leather for car seats according to the present invention and a manufacturing method thereof will be described in detail with reference to the accompanying drawing.

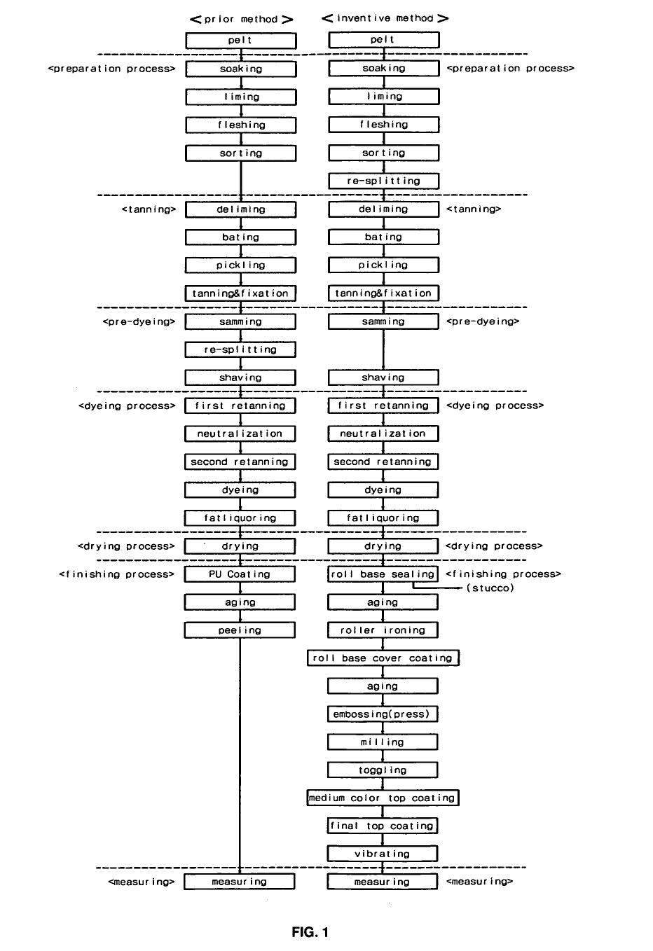

FIG. 1 is a process flowchart showing a method for manufacturing split leather for car seats according to the present invention. As shown in FIG. 1, the method of the present invention sequentially comprises a preparation process, a tanning process, a pre-dyeing process, a dyeing process, a drying process and a finishing process, and is divided into the following detailed steps. Each of the detailed steps and the object of the step are as follows. The conditions of each of the detailed steps are widely known in the technical field to which the present invention pertains, and if necessary, some of the steps may be in reverse order, be omitted, or be carried out together with other steps.

1) Preparation Process

First, the preparation process is a process of preparing the tanning process, which is a main process of processing leather, and it sequentially comprises soaking, liming, fleshing, sorting and re-splitting.

A) Soaking

Because unprocessed leather is stored in a low-temperature storehouse at about 10° C. using a salting method, it is soaked in water for a long time to remove salt, used in the preservation of the pelt, therefrom, so as to remove contaminants attached thereto and replenish the portion lost due to salting, thus restoring it to the original pelt state. Herein, the water content of the pelt is restored from 40% to 70%.

B) Liming

In the liming step, the pelt is soaked in a saturated solution of lime to swell the leather, facilitate the removal of fur, while it is alkalized to plump the tissue and remove unnecessary proteins, such as pelt fur or epidermal keratin layer. Thus, the fur, epidermal layer, water-soluble protein, fat and the like of the pelt are removed, and the fibrous tissue is swollen.

C) Fleshing

Unnecessary meat, connective tissue, fat and the like are mechanically removed, and the loose and tattered portions of the hide are trimmed.

D) Sorting

The useless edge of the pelt is removed, and the pelt is graded according to the surface condition thereof and classified according the intended use thereof.

E) Re-Splitting

The present invention is characterized in that the pelt is tanned after further performing splitting, without tanning the pelt immediately after the preparation process, as in the prior grain leather. That is, the prior grain leather is evenly tanned, even when it is subjected to the tanning process immediately after the preparation process, but the split leather must be further split, because it has a large thickness and contains a thick fatty acid, and thus is not easily tanned.

The pelt is split into an upper grain layer and a split layer, having a thickness of 2.5-4 mm. Then, the split layer is re-separated into split leather to have a thickness of 1.8-2.5 mm starting from the upper side thereof, using a splitting machine. Thus, the fatty layer on the back side of the pelt is detached, so that the thickness of the split leather is reduced. Thus, the split leather is evenly tanned in a subsequent tanning process, which is a main process, so that properties (e.g., heat resistance, durability, softness and tensile strength) required in leather such as grain leather are improved.

Accordingly, the present invention solves the problem with the prior art in that raw materials are not evenly added to the split leather, because the re-splitting process is carried out after the tanning process, and thus the pelt, which is in the tanning process, is thick.

2) Tanning Process

The properties of leather are likely to change at 42-43° C. Thus, the tanning process is carried out to allow the metal chrome (Cr⁺) to bind to collagen in the leather in order to improve the properties of the leather.

The tanning process comprises deliming, bating, tanning and fixation.

A) Deliming

If lime remains intact in the leather, the leather becomes hard and is not dyed. Thus, deliming is carried out to remove lime, neutralize alkali, remove spherical proteins, increase the softness of the leather and facilitate subsequent processes.

First, cow leather, from which fur has been removed by treatment with lime water, is subjected to deliming using, based on the weight of the split leather, 0.1-2 wt % of a nitrogen-based deliming agent or 0.1-2.0 wt % of a nitrogen-free deliming agent or a mixture of the deliming agents, in a drum for 10-240 minutes. As the nitrogen-based deliming agent, ammonium sulfate ((NH₄)₂SO₄), which is currently widely used, is used. Herein, it is effective to use water having a temperature of about 30° C. and a small amount of a surfactant.

Meanwhile, the leather subjected to the deliming step is subjected to bating.

B) Bating

This is a step of removing unnecessary proteins such as keratin from the surface of the split layer to make the grain fine. An enzyme is added to the drum containing the resulting leather, and the leather is subjected to the bating step for 10-180 minutes. Then, the fiber of the resulting leather becomes soft.

C) Pickling

This is carried out to acidify the pelt before performing tanning to preserve the leather, subjected to the bating step, such that the tanning can be smoothly carried out. After 8% salt is applied to the resulting leather, the leather is immersed in a solution (pH 2.6-2.7), comprising 0.5-0.7 wt % of 85% formic acid (dilution rate=1:5) and 1.1 wt % of 96% sulfuric acid (dilution rate=1:10), for 120-180 minutes.

D) Tanning

This is carried out to physically and chemically stabilize the split leather, subjected to the pickling step, to prevent it from deterioration and change it into a safe material which can be stored for a long time. That is, unlike a pelt, leather tanned with naturally available minerals, such as [Cr₂(SO₄)₃], aluminum or phosphorus, to convert the limed pelt in the animal fiber state into useful fiber through the pickling operation, has a wet blue or wet white color, is soft and highly flexible, does not deteriorate, thus enabling long-term storage, has high heat resistance and does not undergo the curing of proteins. For this reason, the tanning process is the most important step in the leather manufacturing process. That is, the tanning operation aims to convert the collagen protein of the pelt to a stable material, which does not deteriorate, has heat resistance and softness to thus adapt to physical and chemical changes, and is suitable for the intended use thereof.

Herein, the chrome serves to convert animal fiber to useful fiber, and magnesium oxide, which fixes the chrome, is slowly dissolved to serve to prevent a rapid increase in pH and fix the tanning agent to the fiber so as to fix tanning effects. Oil is mainly marine oil and serves as a lubricant to increase the feel and physical properties of the leather. In this operation, about 4-6 wt % (preferably 4-5 wt %) of chrome (Cr) is added, about 0.4-0.7 wt % (preferably 0.45-0.6 wt %) of magnesium oxide (MgO) is added thereto, and about 0.1-0.5% (preferably 0.3-0.5 wt %) of marine oil, as stable oil, is added thereto, because all chemicals are sensitive to pH. Then, the resulting leather is tanned in a drum for 1-10 hours.

E) Fixation

In order to increase the physical strength of the split leather subjected to the tanning operation, the split leather is fixed for 1-2 days.

3) Pre-Dyeing Process

The pre-dyeing process comprises samming and shaving operations.

A) Samming

If the leather is wet with water during the period from the tanning process to the aging process, it is not easily shaved. Samming is carried out to mechanically remove water from the leather so as to precisely adjust the thickness of the leather in a subsequent shaving step. The samming is carried out to adjust the water content of the leather from 80% to 45-55%.

B) Shaving

The shaving step is carried out to adjust the thickness of the final product. For uniform dyeing, the back side of the split layer, adjusted to a thickness of 2.5-4 mm in the splitting step, is mechanically shaved again depending on the intended use thereof. Herein, the split leather is uniformly shaved to a thickness of about 1.2-1.4 mm.

4) Dyeing

The dyeing step is carried out to impart colors and improve other required properties, such as water resistance, tensile strength and tearing strength, and comprises first retanning, neutralization, second retanning, dyeing and fatliquoring operations.

A) First Retanning

Although the leather subjected to the chrome tanning process may also be used as a product after subsequent processes, the texture of the fiber in the abdominal pelt, which is generally used as an animal pelt, is relatively loose, and if the low-density fiber tissue is tanned only with chrome, it becomes thin upon drying and it is difficult to obtain leather having a tight sensation. For this reason, a deodorant and acrylic agent are used to reduce the friction between fibers and impart softness, elasticity and a tight sensation to leather.

In the first retanning operation, the leather is retanned with 4-6 wt % of chrome, 0.5-1.0 wt % of a deodorant and 1 wt % of acrylic resin. When the first retanning is carried out, the leather has a tight and soft tactile feel and is also deodorized.

B) Neutralization

Because the leather subjected to the first retanning operation has a pH of about 3.7, a neutralization operation is carried out to increase the pH so as to facilitate the penetration of dyes, syntans and oil components. The leather is neutralized to pH 4.2-6.7, and preferably pH 5.2-5.4. Herein, a neutralizing agent, such as sodium formate or sodium bicarbonate, is used. Also, to soften the leather, marine oil and polyamide carboxylic acid are added to the leather, and then the leather is rotated for 2-4 hours.

C) Second Retanning

The neutralized leather is subjected to second retanning. In the second retanning operation, polyamide carboxylic acid resin, marine oil, acid dyestuff, polyvinyl resin, polyphenol and formic acid are added to the leather, and then the leather is rotated for 10-240 minutes. Herein, the polyamide carboxylic acid serves to make the fiber elastic, the oil serves to soften the fiber, and the dyestuff shows color. Also, the surface of the leather is sealed with the polyvinyl resin, and the dyestuff is fixed by the formic acid.

D) Dyeing

The dyeing of the leather is a process comprising mixing the leather with water-soluble dyestuffs in a container, which can be maintained at a constant temperature, and uniformly applying the dyestuffs to the leather through physical operations to impart various colors. For example, the split leather is primarily dyed with formic acid at a temperature of 20-70° C., and preferably 40-60° C. The dyeing time varies depending on the shape of the leather to be dyed, but is generally 20-180 minutes. The desired color is obtained through primary dyeing, and secondary dyeing may also be carried out after the primary dyeing.

E) Fatliquoring

When the dyed leather is dried, it becomes too hard, and is thus not suitable for use. For this reason, fatliquoring is carried out to inject mineral oil and fat between the fibers of the leather to reduce friction therebetween and act as a lubricant. Also, it is carried out to maintain the softness of the leather, increase the yield of the leather, and protect the leather (impart water resistance). Before, after or during the dyeing, conventional additives, such as a deodorant and an antistatic agent, may additionally be added to the dye bath. At the end of the dyeing process, the leather can be acidified with formic acid, and the solution is continuously circulated for 1 hour.

5) Drying

Because the drying process has a close connection with the tactile feel, thickness, color and yield of the leather, it is important to maintain the ideal temperature, humidity and time. The drying process is carried out by continuously circulating air to evaporate water contained in the leather fiber, and can be divided into natural drying and artificial drying. In the present invention, the leather is dried for 1-2 days through toggle drying, vacuum-press drying, natural drying, or a combination thereof. After the drying process is performed, the leather has a water content of about 8-12%.

6) Finishing

During the drying process, part of the leather is excessively dried to become hard, and a lot of shrinkage occurs. The finishing process is a process of applying water to prevent damage to the fiber tissue in subsequent processes (staking and milling) and soften the fiber tissue. It is carried out to form a protective film on the split leather so as to prevent the leather from contamination with water, dust, oil and the like, reduce the difference from grain leather and provide gloss and a soft tactile feel. It sequentially comprises a roll base sealing step of blending pigments and adhesives with chemicals depending on the color of the leather and spraying the blend onto the surface of the leather, aging, roller ironing, roll base cover coating, aging, embossing (pressing), milling, toggle drying, medium color top coating, final top coating and vibration stacking.

A) Roll Base Sealing

This is a step of adding a sealing material to the rough surface of the leather to smooth the surface thereof. In this step, a urethane resin mixture, comprising 100 parts by weight of a 1:1 mixture of filler silica and pigment, 700-800 parts by weight of a water-based material and 100-150 parts by weight of a urethane binder, is applied on the surface of the split leather using a dry direct coating method after the dyeing process. Preferably, a urethane resin mixture (Stucco), comprising 700-800 g of a water-based material, 100-150 g of a urethane binder (urethane copolymer), 50 g of a silica modifier as a filler, and 50 g of a pigment, is applied on the split leather using a roller coater.

B) Aging

In this step, the split leather is aged for about 1 day to solidify the mixture.

C) Roller Ironing

To smooth out the wrinkles or improve the physical properties of the leather, this step is carried out under conditions of 100° C. and 80 kg f/cm² to smooth the the leather surface.

D) Roll Base Cover Coating

This step is the second preliminary coating step, in which a preliminary color is applied on the leather using a coating solution, comprising 100 parts by weight of a mixture of wax and oil, 180-200 parts by weight of filler silica, 150-160 parts by weight of a pigment, 230-150 parts by weight of an acrylic binder, 300-350 parts by weight of a urethane binder and 1-200 parts by weight of a urethane top coat, through a dry direct coating method. Preferably, a coating solution, comprising a mixture of wax and oil, 180-220 g of a filler, 150-160 g of a pigment, 230-250 g of an acrylic binder and 300-350 g of a urethane binder is coated on the leather.

E) Aging

In this step, the leather is aged to solidify the mixture.

F) Embossing Press

This is a step of forming patterns on the leather using a patterned press plate. This step is carried out at a temperature of 85° C.±5° C. and a pressure of 200-250 kg f/cm² for 5 seconds.

G) Milling

In this step, the leather is placed in a drum, which is then rotated to rub the leather by friction. Through the milling step, the fiber structure, hardened due to the evaporation of water, is relaxed, the leather has a softness of more than 5.5, and the closed pores of the leather are opened to facilitate chemical treatment and subsequent processes.

H) Toggling

The leather is picked up with pincers and pulled taut to smooth out it. This step makes the leather surface elegant and smooth, such that the final leather product does not excessively stretch.

i) Medium Color Top Coating

This step is carried out to impart the final color to the split leather. In the present invention, the leather is coated in several steps, and thus, the leather is coated stably compared to the case where leather is coated in a single step. Accordingly, the present invention has the effects of preventing cracking of the coating layer and providing a uniform appearance to the leather. In this step, a preliminary protective film, which determines the final color of the split leather, is formed using a coating solution, comprising 100 parts by weight of a pigment, 70-90 parts by weight of wax and oil, 120-200 parts by weight of filler silica, 250-300 parts by weight of an acrylic binder, 300-350 parts by weight of a urethane binder, 150-200 parts by weight of a urethane top coat, 20 parts by weight of a silicone modifier and 1-20 parts by weight of a crosslinker, through a dry direct coating method. Preferably, a mixture, comprising 70-90 g of a mixture of wax and oil, 120-200 g of a filler, 100 g of a pigment, 250-300 g of an acrylic binder, 300-350 g of a urethane binder, 150-200 g of a urethane top coat, 20 g of a silicone modifier and 1-20 g of a crosslinker (isocyanate), is coated on the leather surface.

J) Final Top Coating

This step is carried out to form a final coating film protecting the leather surface. In this step, a final protective film is formed on the leather surface using a coating solution, comprising 100 parts by weight of a urethane binder, 550-650 parts by weight of a urethane top coat, 45-55 parts by weight of a silicone antifouling agent, 100-150 parts by weight of a silicone modifier and 100-150 of a crosslinker, through a dry direct coating method. Preferably, a coating solution, comprising 550-650 g of a urethane top coat, 100 g of a urethane binder, 45-55 g of a silicone antifouling agent, 80-120 g of a silicone modifier and 100-150 g of an isocyanate crosslinker, is coated on the leather surface.

K) Vibration Staking

This step is an operation of physically beating the leather, hardened by drying, to make it soft. In this step, the leather is dried in a drying chamber at 150° C. for 1 minute, and is then ironed in an ironing system at 140° C. for 1 minute. It contributes to an improvement in the tactile feel and yield of the leather.

7) Measuring

The leather, subjected to the finishing process, is subjected to a measuring process, in which the area of the leather is measured in S/F(Ft²), and the measured leather is packaged.

Hereinafter, the present invention will be described in further detail with reference to a preferred embodiment, but the scope of the present invention is not limited to the embodiment. It is particularly of note that the present invention is applicable to general processes and mechanical processes for manufacturing leather products.

Table 1 below shows the amounts of components used in each step of a process of manufacturing split leather for car seats according to a preferred embodiment of the present invention. In Table 1, the contents of the components are given in wt % relative to the weight of the pelt resulting from the foregoing step. That is, the contents of chemicals (including a surfactant) in the tanning process are given in wt % relative to the weight of the pelt, and the contents of chemicals in the dyeing process are given in wt % relative to the weight of the pelt resulting from the tanning process. However, the contents of chemicals in the finishing process are given in weight parts relative to the total weight of a mixture comprising the chemicals.

According to the components and contents shown in Table 1, the inventive split leather for car seats can be manufactured.

TABLE 1

| | | |
|---|---|---|
| Important Processes | Chemicals | Amounts (%) |

Preparation Process
Tanning Process

| | | |
|---|---|---|
| Deliming | Ammonium sulfate | 2.0 |
| | ((NH₄)₂SO₄) | |
| | Ammonium-free | 2.0 |
| | deliming agent | |
| | Surfactant | 0.2 |
| Bating | Enzyme | 1.0 |
| Pickling | Salt | 8.0 |
| | 85% formic acid (dilution | 0.7 |
| | rate = 1:4) | |
| | 96% sulfuric acid | 1.4 |
| | (dilution rate = 1:8) | |
| Tanning & Fixation | Chrome (Cr) | 6.0 |
| | Magnesium oxide (MgO) | 0.7 |
| | Oil | 0.5 |

Pre-Dyeing Process
Dyeing Process

| | | |
|---|---|---|
| First Retanning | Chrome (Cr) | 6.0 |
| | Deodorant | 0.5 |
| | Acrylic resin | 1.0 |
| Neutralization | Neutralizing agent | 5.0 |
| | (Sodium formate, | |
| | sodium bicarbonate) | |
| | Marine oil | 3.0 |
| | Modified polyamide | 6.0 |
| | carboxylic acid | |
| Second Retanning & | Modified polyamide | 6.0 |
| Fatliquoring | carboxylic acid | |
| | Marine oil | 10.0 |
| | Acid dyestuff | 3.0 |
| | Polyvinyl resin | 2.0 |
| | Formic acid | 3.0 |
| Aging | Formic acid | 0.5 |
| | Deodorant | 1.5 |
| | Antistatic agent | 0.5 |

Finishing Process

| | | |
|---|---|---|
| Roll Base Sealing | Water-based material | 800 parts by weight |
| | Urethane binder | 150 parts by weight |
| | Filler | 50 parts by weight |
| | Pigment | 50 parts by weight |
| Roll Base Cover | Wax and oil | 100 parts by weight |
| Coating | Filler | 220 parts by weight |
| | Pigment | 160 parts by weight |
| | Acrylic binder | 250 parts by weight |
| | Urethane binder | 350 parts by weight |
| | Urethane top coat | 200 parts by weight |
| Medium Color Top | Wax and oil | 90 parts by weight |
| Coating | Filler | 200 parts by weight |
| | Pigment | 100 parts by weight |
| | Acrylic binder | 300 parts by weight |
| | Urethane binder | 300 parts by weight |
| | Urethane top coat | 200 parts by weight |
| | Silicone modifier | 20 parts by weight |
| | Isocyanate crosslinker | 20 parts by weight |
| Final Top Coating | Urethane top coat | 650 parts by weight |
| | Urethane binder | 100 parts by weight |
| | Silicone antifouling | 55 parts by weight |
| | agent | |
| | Silicone modifier | 120 parts by weight |
| | Isocyanate crosslinker | 150 parts by weight |

As described above, to produce a split leather product, which has a luxuriousness close to grain leather and a soft touch and feel, the present invention is characterized in that the pelt is subjected to the re-splitting process after the preparation process without performing the tanning process immediately after the preparation process, the finishing process is performed to make the surface of the split leather similar to grain leather products, and then the finished split leather is manufactured into a final product.

As described above, according to the manufacturing method of the present invention, split leather for car seats, which has a luxuriousness close to that of full-grain leather and a soft touch and feel and shows excellent durability, can be manufactured using a split leather layer, which is unavoidably generated due to the control of thickness of leather during leather manufacturing processes.

Also, according to the present invention, it is possible to give customers a cost advantage.

Moreover, according to the present invention, the range of selection of raw materials for manufacturing car seat leather can be widened, and waste can be recycled to thus reduce the generation of waste, thus helping the environment.

In addition, according to the present invention, leather seats can be diversified and a new product group can be created.

Although the preferred embodiment of the present invention has been described for illustrative purposes, those skilled in the art will appreciate that various modifications, additions and substitutions are possible, without departing from the scope and spirit of the invention as disclosed in the accompanying claims.

What is claimed is:

1. A method for manufacturing split leather for car seats, comprising a preparation process, a tanning process, a pre-dyeing process, a dyeing process, a drying process and a finishing process, wherein the method comprises, after the preparation process, but before the tanning process, a re-splitting process of splitting a pelt into an upper grain layer and a split layer and re-splitting the split layer to re-splitting a split layer and a fatty layer on the backside of the pelt, thus obtaining split leather, and the finishing process comprises sequentially forming a roll base sealing layer, a roll base cover layer, a medium color top coating layer and a final top coating layer on the split leather, thus treating the surface of the split leather.

2. The method of claim 1, wherein the roll base sealing layer according to the present invention is formed using a roll base sealing process, in which a urethane resin mixture, comprising 100 parts by weight of a 1:1 mixture of filler silica and pigment, 700-800 parts by weight of water-based material and 100-150 parts by weight of a urethane binder, is applied on the surface of the split leather after the dyeing process through a dry direct coating method.

3. The method of claim 2, wherein the roll base cover coating layer according to the present invention is formed using a roll base cover coating process, in which a coating solution, comprising 100 parts by weight of a mixture of wax and oil, 180-200 parts by weight of filler silica, 150-160 parts by weight of filler silica, 230-250 parts by weight of an acrylic binder, 300-350 parts by weight of a urethane binder and 1-200 parts by weight of a urethane top coat, is applied on the surface of the split leather using a dry direct coating method, thus applying a preliminary color.

4. The method of claim 3, wherein the medium color top coating layer is formed using a medium color top coating process, in which a coating solution, comprising 100 parts by weight of a pigment, 70-90 parts by weight of wax and oil, 120-200 parts by weight of filler silica, 250-300 parts by weight of acrylic binder, 300-350 parts by weight of a urethane binder, 150-200 parts by weight of a urethane top coat, 20 parts by weight of a silicone modifier and 1-20 parts by weight of a crosslinker, is coated on the surface of the split leather through a dry direct coating method, thus determining the final color of the split leather and forming a preliminary protective film.

5. The method of claim 4, wherein the final top coating layer according to the present invention is formed using a final top coating process, in which a coating solution, comprising 100 parts by weight of a urethane binder, 550-650 parts by weight of a urethane top coat, 45-55 parts by weight of a silicone antifouling agent, 80-120 parts by weight of a silicone modifier and 100-150 parts by weight of a crosslinker, is applied on the surface of the split leather through a dry direct coating method, thus forming a final protective film.

6. Split leather for car seats, manufactured according to the method of claim 1.
